(19) United States
(12) Patent Application Publication
(10) Pub. No.: US 2025/0357668 A1
(43) Pub. Date: Nov. 20, 2025

(54) Foam Antenna

(71) Applicant: KYOCERA AVX Components (San Diego), Inc., San Diego, CA (US)

(72) Inventor: Francisco Carlos Sanchez Ortiz, San Diego, CA (US)

(21) Appl. No.: 19/207,840

(22) Filed: May 14, 2025

Related U.S. Application Data
(60) Provisional application No. 63/647,336, filed on May 14, 2024.

(51) Int. Cl. H01Q 9/04; H01Q 15/14

(52) U.S. Cl. CPC H01Q 9/0414; H01Q 15/14

(57) ABSTRACT

An antenna is provided. The antenna includes one or more foam carriers having a dielectric constant that is less than about 2. The antenna further includes one or more print-defined or foil-defined antenna layers on one or more surfaces of the one or more foam carriers.

### PRIORITY CLAIM

The present application is based on and claims priority to U.S. Provisional Application 63/647,336 having a filing date of May 14, 2024, which is incorporated by reference herein.

### FIELD

The present disclosure relates generally to an antenna, and more specifically to an antenna having a foam carrier.

### BACKGROUND

Antennas can be used to facilitate wireless communication between devices. It can be desirable for antennas to operate with a high efficiency to improve wireless communication between devices. Antennas may be incorporated into a variety of different types of devices to provide for wireless communication.

### SUMMARY

Aspects and advantages of embodiments of the present disclosure will be set forth in part in the following description, or can be learned from the description, or can be learned through practice of the embodiments.

One example aspect of the present disclosure is directed to an antenna. The antenna includes one or more foam carriers having a dielectric constant that is less than about 2. The antenna further includes one or more print-defined or foil-defined antenna layers on one or more surfaces of the one or more foam carriers.

Another example aspect of the present disclosure is directed to a an antenna. The antenna includes a first foam carrier having a first surface and a second surface, the first surface opposite to the second surface. The antenna further includes a plurality of print-defined or foil-defined antenna layers. The plurality of print-defined or foil-defined antenna layers includes a first antenna layer on the first surface of the first foam carrier. The plurality of print-defined or foil-defined antenna layers further includes a second antenna layer on the second surface of the first foam carrier.

Another example aspect of the present disclosure is directed to an antenna. The antenna includes a plurality of foam carriers. The antenna further includes a plurality of print-defined or foil-defined antenna layers on one or more surfaces of the plurality of foam carriers. The plurality of antenna layers include a first antenna layer comprising one or more antenna radiating elements. The plurality of antenna layers further include a second antenna layer separated from the first antenna layer by a first foam carrier of the plurality of foam carriers, the second antenna layer comprising one or more antenna reflector elements associated with the one or more antenna radiating elements. The plurality of antenna layers further include a third antenna layer separated from the second antenna layer by a second foam carrier of the plurality of foam carriers, the third antenna layer comprising one or more antenna grounding elements associated with the one or more antenna radiating elements.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example antenna according to example embodiments of the present disclosure;

FIGS. 2A-2C provide various side views of example antennas according to example embodiments of the present disclosure;

FIGS. 3A-3B depict various example antenna layers according to example embodiments of the present disclosure;

FIGS. 4A-4D depict various example antenna elements according to example embodiments of the present disclosure;

FIG. 5 provides a side view of an example antenna according to example embodiments of the present disclosure; and

FIG. 6 provides a side view of example film layers of an antenna according to example embodiments of the present disclosure.

Repeat use of reference characters in the present specification and drawings is intended to represent same or analogous features or elements of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value refers to a value that falls within 10% of the stated numerical value.

Some antennas may include one or more antenna elements on a carrier. In general, characteristics of an antenna carrier (e.g., shape, size, material, dielectric constant, air content, etc.) may affect the performance of the antenna. For instance, an electromagnetic wave propagating through the carrier may be affected by the dielectric constant of the carrier. In addition, antenna production associated with some antenna carriers may be challenging. For instance, some carrier materials may be expensive and difficult to configure into a suitable shape. Furthermore, applying the antenna elements to a surface of some carriers may prove challenging.

As such, example aspects of the present disclosure are directed to an antenna having one or more antenna layers on a foam carrier. The one or more antenna layers may be print-defined or foil-defined antenna elements that include one or more antenna elements (e.g., antenna radiating element(s), antenna reflector element(s), antenna grounding element(s), antenna parasitic element(s) etc.) positioned on/along a surface of the foam carrier.

The antenna as described herein may be used in a wide variety of applications. For example, the antenna may be implemented in an electronic device to facilitate wireless communication with other devices (e.g., remote devices). In some embodiments, the antenna may be configured to facilitate communication over one or more frequency bands/protocols. For instance, the antenna may be operable over one or more frequency bands associated with cellular (e.g., long term evolution (LTE)), Wi-Fi, and/or Bluetooth (BT) systems or protocols.

Aspects of the present disclosure provide for multiple technical effects and benefits. For example, the characteristics of the foam carrier may provide for improved antenna performance. For instance, the foam carrier may have a dielectric constant that is less than about 2, which may provide for reduced energy losses. The foam carrier may provide for a durable, light weight, cost-effective carrier material with a desirable strength to weight ratio. In addition, a foam carrier may be manufactured (e.g., configured) into any suitable shape.

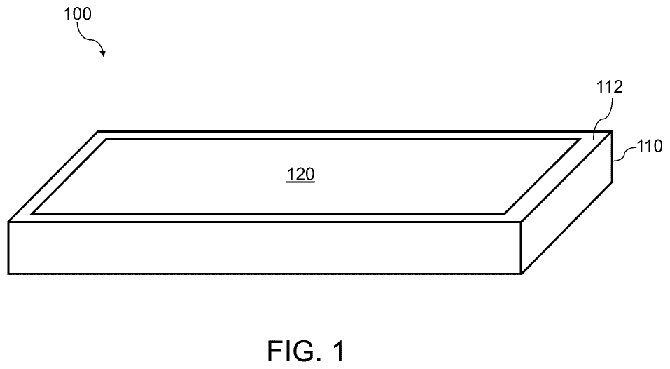

Referring now to the FIGS., FIG. 1 provides a perspective view of an example antenna 100 according to example embodiments of the present disclosure. As shown, antenna 100 includes a foam carrier 110 and a print-defined or foil-defined antenna layer 120 on a surface 112 of foam carrier 110.

In some embodiments, foam carrier 110 may be defined by its dielectric constant. For instance, foam carrier 110 may have a dielectric constant (k) that is less than about 2, such as less than about 1.5, such as about 1. In some embodiments, foam carrier 110 may have a dielectric constant (k) that is between about 2 and about 1.

Foam carrier 110 may include any suitable foam material. In some embodiments, foam carrier 110 may include one or more foam materials, such as open cell foam or closed cell foam or any suitable combination of close cell foam and open cell foam. For instance, foam carrier 110 may include one or more of polystyrene foam, polyurethane foam, polyethylene foam, polypropylene foam, or ethylene propylene diene monomer (EPDM) rubber foam. In some embodiments, foam carrier 110 may include a combination of two or more foam materials, such as polystyrene foam, polyurethane foam, polyethylene foam, polypropylene foam, or ethylene propylene diene monomer (EPDM) rubber foam.

While foam carrier 110 is depicted in FIG. 1 as being generally rectangular in shape, those of ordinary skill in the art will understand that foam carrier 110 may be any suitable shape or size without deviating from the scope of the present disclosure.

As illustrated in FIG. 1, a print-defined or foil-defined antenna layer 120 may be on a surface 112 of foam carrier 110. In some embodiments, antenna layer 120 may be positioned on a surface 112 of foam carrier 110 that is greater in surface area than the adjacent surfaces of the foam carrier 110. Additional antenna layer(s) 120 may be positioned on other surfaces of foam carrier 110, such as a surface opposite to surface 112.

Antenna layer 120 may include one or more antenna elements, such as one or more antenna radiating elements, one or more antenna reflector elements, one or more antenna grounding elements, etc. For instance, antenna layer 120 may include any suitable number of antenna elements having any suitable shape/size without deviating from the scope of the present disclosure. For instance, in some embodiments, antenna layer 120 may be an antenna array having a plurality of antenna elements. Alternatively, antenna layer 120 may include a singular antenna element. Furthermore, the one or more antenna elements of antenna layer 120 may have any suitable shape (e.g., square shape, rectangular shape, circular shape, irregular shape, etc.).

Antenna layer 120 may be a print-defined antenna layer or a foil-defined antenna layer. For instance, the print-defined or foil-defined antenna layer 120 may be applied (e.g., deposited, formed) on surface 112 of foam carrier 110 using, for instance, any suitable printing or foil application technique.

In some embodiments, antenna layer 120 may be a print-defined antenna layer. In such embodiments, the one or more antenna elements of antenna layer 120 may be deposited (e.g., formed) on foam carrier 110 using any suitable printing application technique. For instance, a print-defined antenna layer may be applied to surface 112 of foam carrier 110 by an ink printing technique or process, such as silkscreen printing, flexography, pad printing, inkjet printing, sublimation printing, or stamping printing. Accordingly, the one or more antenna elements of a print-defined antenna layer may be formed from a conductive ink, such as silver conductive ink, copper conductive ink, gold conductive ink, or zinc conductive ink.

In other embodiments, antenna layer 120 may be a foil-defined antenna layer. For instance, the one or more antenna elements of antenna layer 120 may be applied (e.g., formed) on foam carrier 110 using any suitable foil application technique or process, such as heat transfer foil, pressure transfer foil, foil stamping, or imprint foil. Accordingly, the one or more antenna elements of a foil-defined antenna layer may be formed from any suitable conductive foil, such as aluminum conductive foil or copper conductive foil.

In some embodiments, antenna layer 120 may be positioned directly on surface 112 of foam carrier 110. In alternative embodiments, a film layer having an electrically insulating material may be positioned between antenna layer 120 and the foam carrier 110.

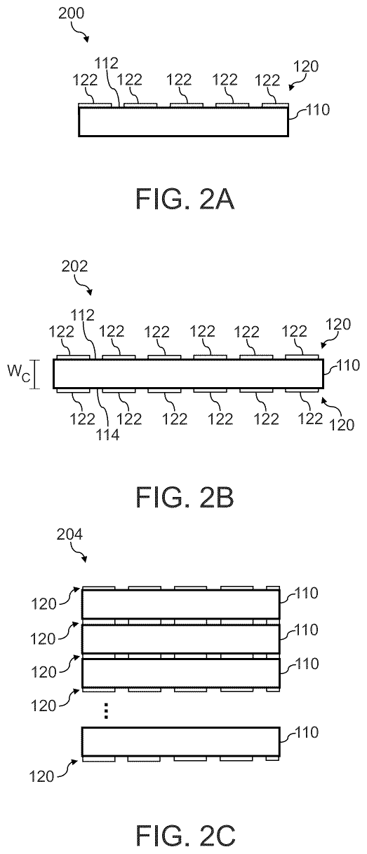

While antenna 100 is depicted in FIG. 1 as having a singular antenna layer 120 on a surface 112 of singular foam carrier 110 for purposes of illustration and discussion, those of ordinary skill in the art, using the disclosure provided herein, will understand that antenna 100 may include any suitable number of antenna layers 120 on one or more surfaces of any suitable number of foam carriers 110. For instance, antenna 100 may include a plurality of antenna layers 120 positioned on a plurality of surfaces of foam carrier 110. Additionally/alternatively, antenna 100 may include a plurality of foam carriers 110 with antenna layers 120 positioned on one or more surfaces of the plurality of foam carriers 110. For instance, in some embodiments, antenna 100 may be a stack antenna. As such, FIGS. 2A-2C provide side views of various configurations of example antenna layer(s) 120 and foam carrier(s) 110 of example antennas according to example embodiments of the present disclosure.

While antenna layers 120 are depicted in FIGS. 2A-2C as antenna arrays having a plurality of antenna elements 122 for purposes of illustration and discussion, those of ordinary skill in the art, using the disclosure provided herein, will understand that each antenna layer 120 depicted in FIGS. 2A-2C may include any suitable number/configuration of antenna elements 122 without deviating from the scope of the present disclosure.

Each antenna layer 120 depicted in FIGS. 2A-2C may be a print-defined antenna layer or a foil-defined antenna layer. For instance, antenna layers 120 may be applied (e.g., deposited, formed) using, for instance, any suitable printing or foil application technique or process. For instance, a print-defined antenna layer 120 may be applied on a carrier 110 by an ink printing technique or process (e.g., silkscreen printing, flexography, pad printing, inkjet printing, sublimation printing, stamping printing, etc.) while a foil-defined antenna layer 120 may be applied on a carrier 110 by a foil application technique or process (e.g., heat transfer foil, pressure transfer foil, foil stamping, imprint foil, etc.). Accordingly, a print-defined antenna layer 120 may be formed from, for instance, a conductive ink (e.g., silver conductive ink, copper conductive ink, gold conductive ink, zinc conductive ink, etc.), while a foil-defined antenna layer 120 may be formed from, for instance, a conductive foil (e.g., aluminum conductive foil, copper conductive foil, etc.).

Referring now to FIG. 2A specifically, a side view of an example antenna 200 according to example embodiments of the present disclosure is provided. As shown, antenna 200 may include a foam carrier 110 and an antenna layer 120 positioned on first surface 112 of foam carrier 110. As previously described with reference to FIG. 1, antenna layer 120 may include one or more antenna elements 122. In some embodiments, such as that shown in FIG. 2A, antenna layer 120 may be an antenna array having a plurality of antenna elements 122. As shown, antenna layer 120 may be positioned directly on surface 112 of foam carrier 110. For instance, antenna layer 120 may be a print-defined antenna layer or a foil-defined antenna layer with each antenna element 122 applied directly to surface 112 of foam carrier 110.

FIG. 2B provides a side view of an example antenna 202 according to example embodiments of the present disclosure. As shown, antenna 202 may include a foam carrier 110 and a first antenna layer 120 positioned on a first surface 112 of foam carrier 110. In addition, antenna 202 may include a second antenna layer 120 positioned on a second surface 114 of foam carrier 110. As illustrated, second surface 114 may be opposite to first surface 112 of foam carrier 110. For instance, the first surface 112 of foam carrier 110 may face a direction that is generally opposite to a direction that second surface 114 of foam carrier 110 faces. Accordingly, the antenna layer 120 positioned on the first surface 112 may be separated from the antenna layer 120 positioned on the second surface 114 by a width (W_{C}) of foam carrier 110.

FIG. 2C provides a side view of an example antenna 204 according to example embodiments of the present disclosure. As previously described with reference to FIG. 1, antenna 100 may include a plurality of foam carriers 110 with antenna layers 120 positioned on one or more surfaces of the plurality of foam carriers 110. As shown in FIG. 2C, antenna 204 may be a stack antenna having a plurality of antenna layers 120 one or more surfaces of a plurality of foam carriers 110. For instance, each antenna layer 120 may be separated from an adjacent antenna layer 120 by a foam carrier 110.

In some embodiments, antenna 204 may include at least four stacked antenna layers 120. For instance, four antenna layers 120 may be separated by three foam carriers 110. As indicated by FIG. 2C, antenna 204 may further include any suitable number of additional antenna layers 120 separated by an additional foam carriers 110 without deviating from the scope of the present disclosure.

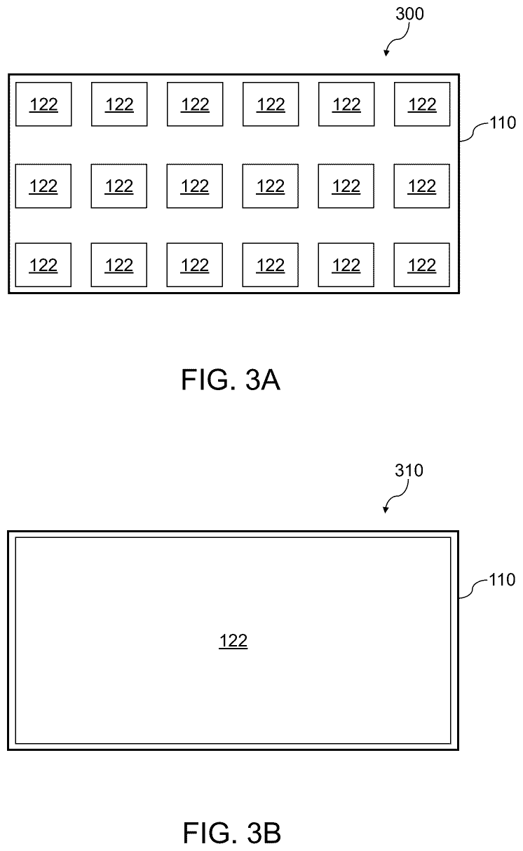

Referring now to FIGS. 3A-3B, various example antenna layers of an antenna according to example embodiments of the present disclosure are provided. Each antenna layer 300, 310 may be on a surface of a foam carrier, such as foam carrier 110.

In some embodiments, each antenna layer 300, 310 depicted in FIGS. 3A-3B may be a print-defined antenna layer or a foil-defined antenna layer. For instance, each antenna layer 300, 310 may be a print-defined antenna layer deposited (e.g., formed) by, for instance, an ink printing technique or process such as silkscreen printing, flexography, pad printing, inkjet printing, sublimation printing, stamping printing, etc. A print-defined antenna layer may include one or more antenna elements formed from a conductive ink, such as silver conductive ink, copper conductive ink, gold conductive ink, zinc conductive ink, etc. Alternatively, antenna layers 300, 310 may be foil-defined antenna layers manufactured (e.g., formed) using a foil application technique or process, such as heat transfer foil, pressure transfer foil, foil stamping, imprint foil, etc. A foil-defined antenna layer may include one or more antenna elements formed from, for example, aluminum conductive foil, copper conductive foil, etc.

Referring now specifically to FIG. 3A, an example antenna layer 300 is provided according to example embodiments of the present disclosure. As shown, antenna layer 300 may be an antenna array having a plurality of antenna elements 302 on a surface of a foam carrier 110. Specifically, antenna layer 300 may include a plurality of antenna elements 302 arranged in an array extending along a surface of carrier 110. While antenna layer 300 is illustrated in FIG. 3A as having an antenna array with six antenna elements 122 by three antenna elements 122 (e.g., eighteen antenna elements 122 in all) for purposes of illustration and discussion, those of ordinary skill in the art, using the disclosure provided herein, will understand that antenna layer 300 may include any suitable array configuration having any suitable number of antenna elements 122 without deviating from the scope of the present disclosure. In addition, antenna elements 122 are depicted in FIG. 3A as being generally rectangular in shape for purposes of illustration and discussion. Those of ordinary skill in the art will understand that each antenna element 122 of antenna layer 300 may have any suitable shape, such as a shape that is square, rectangular, circular, or irregular.

In some embodiments, antenna elements 122 of antenna layer 300 may be antenna radiating elements. For instance, multiple antenna elements 122 of antenna layer 300 may be configured to radiate energy that may be combined to provide a radiation pattern of the antenna layer 300. In alternative embodiments, antenna elements 122 of antenna layer 300 may be antenna reflector elements or antenna grounding elements.

FIG. 3B provides another example antenna layer 310 according to example embodiments of the present disclosure. As shown, antenna layer 310 may include a singular antenna element 122 on a surface of a foam carrier 110. In some embodiments, antenna element 122 of antenna layer 310 may be an antenna radiating element. For instance, antenna element 122 of antenna layer 310 may be configured to radiate energy to provide a radiation pattern of the antenna layer 310. In alternative embodiments, antenna element 122 of antenna layer 310 may be an antenna reflector element or an antenna grounding element.

While antenna element 122 is illustrated in FIG. 3B as being generally rectangular and extending along a majority of the surface of foam carrier 110 for purposes of illustration and discussion, those of ordinary skill in the art, using the disclosure provided herein, will understand that the antenna element 122 of antenna layer 310 may have any suitable size and/or shape without deviating from the scope of the present disclosure.

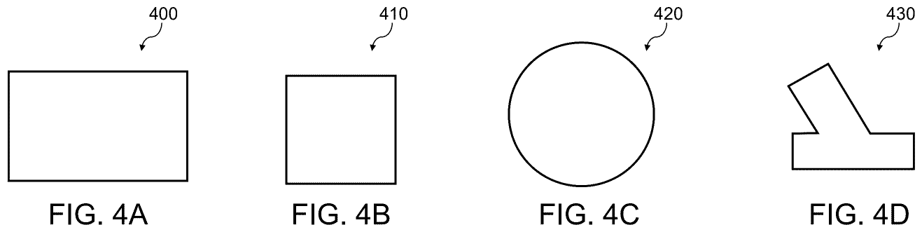

For instance, FIGS. 4A-4D provide top down views of various example antenna elements 400, 410, 420, 430 of an antenna layer according to example embodiments of the present disclosure. As previously described with reference to FIG. 1, each antenna element of antenna layer 120 may have any suitable shape, such as a shape that is square, rectangular, circular, or irregular. As shown in FIGS. 4A-4D, an antenna element may be rectangular in shape, such as antenna element 400. Alternatively, an antenna element may be square in shape, such as antenna element 410 or circular in shape, such as antenna element 420. In some embodiments, an antenna element may be irregularly shaped, such as antenna element 430.

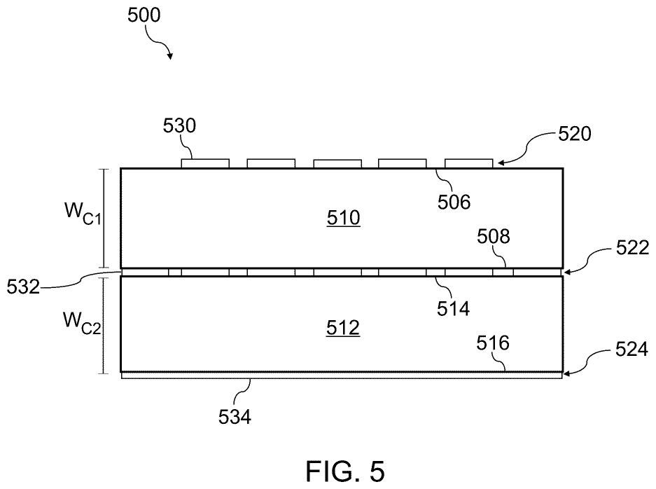

Referring now to FIG. 5, an example antenna 500 is provided according to example embodiments of the present disclosure. As shown, antenna 500 may include a first carrier 510 and a second carrier 512. Both the first carrier 510 and the second carrier 512 may be a foam carrier, such as the foam carrier 110 described with reference to FIGS. 1 and 2A-2C. Antenna 500 may be a stack antenna having a plurality of antenna layers 520, 522, 524 on one or more surfaces of the first foam carrier 510 and the second foam carrier 512. Specifically, antenna 500 may include a first antenna layer 520, a second antenna layer 522, and a third antenna layer 524. As shown, the first antenna layer 520 may be separated from the second antenna layer 522 by the first foam carrier 510 (e.g., by width (W_{C1}) of first foam carrier 510) while the second antenna layer 522 may be separated from the third antenna layer 524 by the second foam carrier 512 (e.g., by width (W_{C2}) of second foam carrier 512). Accordingly, the second antenna layer 522 may be positioned between the first foam carrier 510 and the second foam carrier 512.

In some embodiments, the width (W_{C1}) of first foam carrier 510 may be about the same as the width (W_{C2}) of second foam carrier 512. In alternative embodiments, the width (W_{C1}) of first foam carrier 510 may be different than the width (W_{C2}) of second foam carrier 512.

The first foam carrier 510 and the second foam carrier 512 may each include any suitable foam material. In some embodiments, each foam carrier 510, 512 may have a dielectric constant (k) that is less than about 2, such as less than about 1.5, such as about 1. Additionally or alternatively, each foam carrier 510, 512 may include one or more foam materials, such as open cell foam or closed cell foam or any suitable combination of close cell foam and open cell foam. For instance, each foam carrier 510, 512 may include one or more of polystyrene foam, polyurethane foam, polyethylene foam, polypropylene foam, or ethylene propylene diene monomer (EPDM) rubber foam.

In some embodiments, the first foam carrier 510 may have a dielectric constant that is different than the dielectric constant of the second foam carrier 512. Additionally or alternatively, the first foam carrier 510 may include one or more foam materials that are different than one or more foam materials of the second foam carrier 512.

The first antenna layer 520, second antenna layer 522, and third antenna layer 524 may each be a print-defined or foil-defined antenna layer, such as the antenna layer 120 described with reference to FIGS. 1 and 2A-2C. For instance, each antenna layer 520, 522, 524 may include one or more antenna elements (e.g., antenna radiating element(s), antenna reflector element(s), antenna grounding element(s), etc.).

First antenna layer 520 may include one or more antenna radiating elements 530 configured to radiate energy to provide a radiation pattern of the antenna layer 520. Each of the one or more antenna radiating elements 530 may have any suitable shape. For instance, each antenna radiating element 530 may be rectangular, square, circular, or irregular in shape, such as antenna elements 400, 410, 420, 430 depicted in FIGS. 4A-4B.

In some embodiments, first antenna layer 520 may include a singular radiating element 530, such as the antenna element 122 of antenna layer 310 depicted in FIG. 3B. In alternative embodiments, first antenna layer 520 may be an antenna array having a plurality of antenna radiating elements 530, such as the plurality of antenna elements 122 of antenna layer 300 depicted in FIG. 3A. For instance, multiple antenna radiating elements 530 of antenna layer 520 may be configured to radiate energy that may be combined to provide a radiation pattern of the antenna 500.

Second antenna layer 522 may include one or more antenna reflector elements 532 associated with the one or more antenna radiating elements 530 of the first antenna layer 520. The antenna reflector element(s) 532 may be configured to adjust one or more radiation characteristics of the antenna radiating element(s) 530 of the first antenna layer 520. For instance, the antenna reflector element(s) 532 of second antenna layer 522 may be configured to tune or steer a radiation pattern provided by first antenna layer 520. Additionally or alternatively, antenna reflector element(s) 532 may enhance the radiation power of the antenna radiating element(s) 530.

Each of the one or more antenna reflector elements 532 may have any suitable shape. For instance, each antenna reflector element 532 of second antenna layer 522 may be rectangular, square, circular, or irregular in shape, such as antenna elements 400, 410, 420, 430 depicted in FIGS. 4A-4B. In some embodiments, second antenna layer 522 may include a singular reflector element 532, such as the antenna element 122 of antenna layer 310 depicted in FIG. 3B. In alternative embodiments, second antenna layer 522 may be an antenna array having a plurality of antenna reflector elements 532, such as the plurality of antenna elements 122 of antenna layer 300 depicted in FIG. 3A.

Third antenna layer 524 may include one or more antenna grounding elements 534 associated with the one or more antenna radiating elements 530 of the first antenna layer 520. For instance, the antenna grounding element(s) 534 may provide a ground plane for one or more of the antenna radiating elements 530 of the first antenna layer 520. Each of the one or more antenna grounding elements 534 may have any suitable shape. For instance, each antenna grounding element 534 of third antenna layer 524 may be rectangular, square, circular, or irregular in shape, such as antenna elements 400, 410, 420, 430 depicted in FIGS. 4A-4B.

As shown in FIG. 5, third antenna layer 524 may include a singular antenna grounding element 534, such as the antenna element 122 of antenna layer 310 depicted in FIG. 3B. In alternative embodiments, third antenna layer 524 may be an antenna array having a plurality of antenna grounding elements 534, such as the plurality of antenna elements 122 of antenna layer 300 depicted in FIG. 3A. For instance, third antenna layer 524 may include a plurality of antenna grounding elements 534, each grounding element associated with a corresponding antenna radiating element 530 of the first antenna layer 520.

As shown in FIG. 5, the first antenna layer 520 may be positioned on a first surface 506 of first foam carrier 510. Second antenna layer 522 may be positioned between the first carrier 510 and the second carrier 512, such as on a second surface 508 of first foam carrier 510 and/or on a surface 514 of the second foam carrier 512. Third antenna layer 524 may be positioned on a surface 516 of the second foam carrier 512 that is opposite to the second antenna layer 522.

The first surface 506 of the first foam carrier 510 may be opposite to the second surface 508 of the first foam carrier 510. For instance, the first surface 506 of first foam carrier 510 may face a direction that is generally opposite to a direction that second surface 508 of foam carrier 510 faces. Similarly, surface 514 of the second foam carrier 512 may be opposite to the surface 516 of the second foam carrier 512. For instance, surface 514 of second foam carrier 512 may face a direction that is generally opposite to a direction that surface 516 of second foam carrier 512 faces. Accordingly, surface 506 may face a direction that is generally the same as a direction surface 514 faces, while surface 508 may face a direction that is generally the same as a direction surface 516 faces.

In some embodiments, each antenna layer 520, 522, 524 may be positioned directly on a surface of the first foam carrier 510 or the second foam carrier 512. For instance, first antenna layer 520 may be positioned (e.g., formed) directly on a first surface 506 of the first foam carrier 510. Second antenna layer 522 may be positioned (e.g., formed) directly on a second surface 508 of the first foam carrier 510 and/or on a surface 514 of the second foam carrier 512. Third antenna layer 524 may be positioned (e.g., formed) directly on a surface 516 of the second foam carrier 512.

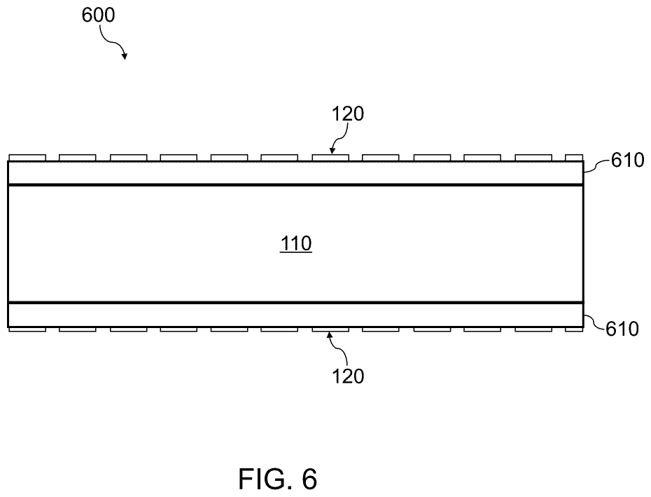

In alternative embodiments, a film layer having an electrically insulating material may be positioned between each antenna layer 520, 522, 524 and the foam carriers 510, 512. Accordingly, antenna 500 may include a plurality of film layers, such as film layers 610 described below in reference to FIG. 6. For instance, a first film layer may be positioned between the first antenna layer 520 and the first foam carrier 510. A second film layer may be positioned between the second antenna layer 522 and the first foam carrier 510. A third film layer may be positioned between the second antenna layer 522 and the second foam carrier 512. A fourth film layer may be positioned between the third antenna layer 524 and the second foam carrier 512.

Referring now to FIG. 6, example film layers of an antenna 600 according to example embodiments of the present disclosure is provided. As shown in FIG. 6, film layers 610 may be positioned between the antenna layers 120 and the foam carrier 110. While antenna 600 is depicted in FIG. 6 as having two film layers 610 positioned between two antenna layers 120 and a singular foam carrier 110 for purposes of illustration and discussion, those of ordinary skill in the art, using the disclosure provided, will understand that film layers 610 may be provided between one or more antenna layers and one or more foam carriers of any antenna provided herein.

Film layers 610 may include an electrically insulating material, such as Mylar (PET/Polyester), PE (Polyethylene), PP (Polypropylene), PS (Polystyrene), etc. Film layers 610 may be applied to carrier 110 using any suitable film application technique or process, such as film application techniques involving adhesives, heat, pressure, or any combination of adhesives, heat, or pressure.

Antenna layers 120 may be applied (e.g., deposited, formed) directly on to the film layer 610 using, for instance, any suitable printing or foil application technique or process. For instance, a print-defined antenna layer 120 may be applied to a film layer 610 by an ink printing technique or process (e.g., silkscreen printing, flexography, pad printing, inkjet printing, sublimation printing, stamping printing, etc.) while a foil-defined antenna layer 120 may be applied to a film layer by a foil application technique or process (e.g., heat transfer foil, pressure transfer foil, foil stamping, imprint foil, etc.). Accordingly, a print-defined antenna layer 120 may be formed on a film layer 610 from, for instance, a conductive ink (e.g., silver conductive ink, copper conductive ink, gold conductive ink, zinc conductive ink, etc.) while a foil-defined antenna layer 120 may be formed on a film layer 610 from, for instance, a conductive foil (e.g., aluminum conductive foil, copper conductive foil, etc.).

In some embodiments, film layers 610 may be applied to the surface of the carrier prior to the application (e.g., formation) of the print-defined or foil-defined antenna layers 120. In alternative embodiments, film layers 610 may be applied to the surface of the carrier after the application (e.g., formation) of the print-defined or foil-defined antenna layers 120 on carrier 110.

One example aspect of the present disclosure is directed to an antenna. The antenna includes one or more foam carriers having a dielectric constant that is less than about 2. The antenna further includes one or more print-defined or foil-defined antenna layers on one or more surfaces of the one or more foam carriers.

In some examples, the one or more foam carriers comprise one or more of polystyrene foam, polyurethane foam, polyethylene foam, polypropylene foam, or ethylene propylene diene monomer (EPDM) rubber foam.

In some examples, each antenna layer of the one or more antenna layers is positioned directly on a surface of the one or more foam carriers.

In some examples, the antenna further includes one or more film layers positioned between the one or more antenna layers and the one or more foam carriers, each film layer of the one or more film layers comprising an electrically insulating material.

In some examples, each antenna layer of the one or more antenna layers comprises an antenna array having a plurality of antenna elements.

In some examples, the one or more antenna layers include a first antenna layer comprising one or more antenna radiating elements, the first antenna layer on a first surface of a first carrier of the one or more foam carriers. In some examples, the one or more antenna layers further include a second antenna layer comprising one or more antenna reflector elements associated with the one or more antenna radiating elements, the second antenna layer on a second surface of the first carrier, the second surface of the first carrier opposite to the first surface.

In some examples, the second antenna layer is positioned between the first carrier and a second carrier of the one or more foam carriers. In some examples, the one or more antenna layers further include a third antenna layer comprising one or more antenna grounding elements associated with the one or more antenna radiating elements, the third antenna layer on a surface of the second carrier opposite to the second antenna layer.

In some examples, the one or more antenna layers are print-defined antenna layers.

In some examples, the one or more antenna layers are foil-defined antenna layers.

Another example aspect of the present disclosure is directed to a an antenna. The antenna includes a first foam carrier having a first surface and a second surface, the first surface opposite to the second surface. The antenna further includes a plurality of print-defined or foil-defined antenna layers. The plurality of print-defined or foil-defined antenna layers includes a first antenna layer on the first surface of the first foam carrier. The plurality of print-defined or foil-defined antenna layers further includes a second antenna layer on the second surface of the first foam carrier.

In some examples, the first foam carrier has a dielectric constant that is less than about 2.

In some examples, the first foam carrier comprises one or more of polystyrene foam, polyurethane foam, polyethylene foam, polypropylene foam, or ethylene propylene diene monomer (EPDM) rubber foam.

In some examples, the antenna further includes a plurality of film layers, each film layer of the plurality of film layers positioned between an antenna layer of the plurality of antenna layers and the first foam carrier, each film layer of the plurality of film layers comprising an electrically insulating material.

In some examples, the antenna further includes a second foam carrier, the second antenna layer positioned between the first foam carrier and the second foam carrier. In some examples, the plurality of antenna layers further include a third antenna layer on a surface of the second foam carrier opposite to the second antenna layer.

In some examples, the first antenna layer comprises one or more antenna radiating elements, the second antenna layer comprises one or more antenna reflector elements associated with the one or more antenna radiating elements, and the third antenna layer comprises one or more antenna grounding elements associated with the one or more antenna radiating elements.

In some examples, at least one antenna layer of the plurality of antenna layers comprises an antenna array having a plurality of antenna elements.

Another example aspect of the present disclosure is directed to an antenna. The antenna includes a plurality of foam carriers. The antenna further includes a plurality of print-defined or foil-defined antenna layers on one or more surfaces of the plurality of foam carriers. The plurality of antenna layers include a first antenna layer comprising one or more antenna radiating elements. The plurality of antenna layers further include a second antenna layer separated from the first antenna layer by a first foam carrier of the plurality of foam carriers, the second antenna layer comprising one or more antenna reflector elements associated with the one or more antenna radiating elements. The plurality of antenna layers further include a third antenna layer separated from the second antenna layer by a second foam carrier of the plurality of foam carriers, the third antenna layer comprising one or more antenna grounding elements associated with the one or more antenna radiating elements.

In some examples, the antenna further includes a plurality of film layers, each film layer of the plurality of film layers positioned between an antenna layer of the plurality of antenna layers and a foam carrier of the plurality of foam carriers, each film layer of the plurality of film layers comprising an electrically insulating material.

In some examples, each foam carrier of the plurality of foam carriers has a dielectric constant that is less than about 2.

In some examples, at least one antenna layer of the plurality of antenna layers comprises an antenna array having a plurality of antenna elements.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An antenna comprising:
one or more foam carriers having a dielectric constant that is less than about 2; and
one or more print-defined or foil-defined antenna layers on one or more surfaces of the one or more foam carriers.

2. The antenna of claim 1, wherein the one or more foam carriers comprise one or more of polystyrene foam, polyurethane foam, polyethylene foam, polypropylene foam, or ethylene propylene diene monomer (EPDM) rubber foam.

3. The antenna of claim 1, wherein each antenna layer of the one or more antenna layers is positioned directly on a surface of the one or more foam carriers.

4. The antenna of claim 1, further comprising:
one or more film layers positioned between the one or more antenna layers and the one or more foam carriers, each film layer of the one or more film layers comprising an electrically insulating material.

5. The antenna of claim 1, wherein each antenna layer of the one or more antenna layers comprises an antenna array having a plurality of antenna elements.

6. The antenna of claim 1, wherein the one or more antenna layers comprises:
a first antenna layer comprising one or more antenna radiating elements, the first antenna layer on a first surface of a first carrier of the one or more foam carriers; and
a second antenna layer comprising one or more antenna reflector elements associated with the one or more antenna radiating elements, the second antenna layer on a second surface of the first carrier, the second surface of the first carrier opposite to the first surface.

7. The antenna of claim 6, wherein the second antenna layer is positioned between the first carrier and a second carrier of the one or more foam carriers,
wherein the one or more antenna layers further comprises:
a third antenna layer comprising one or more antenna grounding elements associated with the one or more antenna radiating elements, the third antenna layer on a surface of the second carrier opposite to the second antenna layer.

8. The antenna of claim 1, wherein the one or more antenna layers are print-defined antenna layers.

9. The antenna of claim 1, wherein the one or more antenna layers are foil-defined antenna layers.

10. An antenna comprising:
a first foam carrier having a first surface and a second surface, the first surface opposite to the second surface; and
a plurality of print-defined or foil-defined antenna layers comprising:
a first antenna layer on the first surface of the first foam carrier; and
a second antenna layer on the second surface of the first foam carrier.

11. The antenna of claim 10, wherein the first foam carrier has a dielectric constant that is less than about 2.

12. The antenna of claim 10, wherein the first foam carrier comprises one or more of polystyrene foam, polyurethane foam, polyethylene foam, polypropylene foam, or ethylene propylene diene monomer (EPDM) rubber foam.

13. The antenna of claim 10, further comprising:
a plurality of film layers, each film layer of the plurality of film layers positioned between an antenna layer of the plurality of antenna layers and the first foam carrier, each film layer of the plurality of film layers comprising an electrically insulating material.

14. The antenna of claim 10, further comprising:
a second foam carrier, the second antenna layer positioned between the first foam carrier and the second foam carrier,
wherein the plurality of antenna layers further comprises:
a third antenna layer on a surface of the second foam carrier opposite to the second antenna layer.

15. The antenna of claim 14, wherein the first antenna layer comprises one or more antenna radiating elements, the second antenna layer comprises one or more antenna reflector elements associated with the one or more antenna radiating elements, and the third antenna layer comprises one or more antenna grounding elements associated with the one or more antenna radiating elements.

16. The antenna of claim 10, wherein at least one antenna layer of the plurality of antenna layers comprises an antenna array having a plurality of antenna elements.

17. An antenna comprising:
a plurality of foam carriers;
a plurality of print-defined or foil-defined antenna layers on one or more surfaces of the plurality of foam carriers, the plurality of antenna layers comprising:
a first antenna layer comprising one or more antenna radiating elements;
a second antenna layer separated from the first antenna layer by a first foam carrier of the plurality of foam carriers, the second antenna layer comprising one or more antenna reflector elements associated with the one or more antenna radiating elements; and
a third antenna layer separated from the second antenna layer by a second foam carrier of the plurality of foam carriers, the third antenna layer comprising one or more antenna grounding elements associated with the one or more antenna radiating elements.

18. The antenna of claim 17, further comprising:
a plurality of film layers, each film layer of the plurality of film layers positioned between an antenna layer of the plurality of antenna layers and a foam carrier of the plurality of foam carriers, each film layer of the plurality of film layers comprising an electrically insulating material.

19. The antenna of claim 17, wherein each foam carrier of the plurality of foam carriers has a dielectric constant that is less than about 2.

20. The antenna of claim 17, wherein at least one antenna layer of the plurality of antenna layers comprises an antenna array having a plurality of antenna elements.
